(19) United States
(12) Patent Application Publication
(10) Pub. No.: US 2015/0214803 A1
(43) Pub. Date: Jul. 30, 2015

(54) MOTOR STATOR, METHOD FOR PREPARING THE MOTOR STATOR AND MOTOR COMPRISING THE MOTOR STATOR

(71) Applicant: Guangdong Welling Motor Manufacturing Co., Ltd., Foshan City (CN)

(72) Inventors: Shoujun Zhang, Foshan City (CN); Wen Fan, Foshan City (CN); Kebin Chen, Foshan City (CN)

(73) Assignee: GUANGDONG WELLING MOTOR MANUFACTURING CO., LTD., Foshan City (CN)

(21) Appl. No.: 14/288,548

(22) Filed: May 28, 2014

(30) Foreign Application Priority Data
Jan. 26, 2014 (CN) 201420052422.9

(51) Int. Cl. H02K 3/34; H02K 15/00; H02K 15/02; H02K 15/085; H02K 3/48; H02K 15/10

(52) U.S. Cl. CPC H02K 3/345; H02K 3/48; H02K 15/10; H02K 15/024; H02K 15/085; H02K 15/0068

(57) ABSTRACT

A motor stator includes a stator core, first and second insulating members and a stator winding. The stator core defines upper and lower ends and has a central through hole and a plurality of stator slots distributed along a circumferential direction of the stator core, and each stator slot includes first and second slot segments. The first insulating member is disposed in the stator slot. The second insulating member is disposed at at least one of the upper and lower ends of the stator core, and defines a central hole and a plurality of grooves corresponding to the plurality of stator slots respectively. A flange is formed on the second insulating member along a peripheral of the groove and fitted within the second slot segment. The stator winding is wound on the stator core and passing through the plurality of stator slots and grooves.

### CROSS-REFERENCE TO RELATED APPLICATION

This application claims priority to and benefits of Chinese Patent Application No. 201420052422.9, filed with the State Intellectual Property Office of P. R. China on Jan. 26, 2014, the entire content of the above-identified application is incorporated herein by reference.

### FIELD

Embodiments of the present invention relate to the field of motor, and more particularly to a motor stator, method for preparing the motor stator and motor comprising the motor stator.

### BACKGROUND

In the related art, in order to insure an enough safe distance between the stator winding and the end surfaces of stator core of a motor, the insulating paper mounted in the stator slot generally extends beyond the end surface of the stator core for a relative long length generally larger than 2.5 mm Such motor stator has some problems: the enamelled wire of the stator winding is relatively long, so that the consumption on the materials is large; the resistance of the stator winding is large and the loss is high and the efficiency of the motor is reduced; poor voltage-withstanding may occur between the stator winding and the stator core; and the stator winding has a large height which requires a large space, so that the compactness of the motor is limited.

### SUMMARY

Embodiments of an aspect of the present invention provide a motor stator. The motor stator includes: a stator core defining upper and lower ends and having a central through hole and a plurality of stator slots, the plurality of stator slots being distributed along a circumferential direction of the stator core and each stator slot including first and second slot segments; a first insulating member disposed in the stator slot; a second insulating member disposed at at least one of the upper and lower ends of the stator core, and defining a central hole and a plurality of grooves corresponding to the plurality of stator slots respectively, and a flange being formed on the second insulating member along a peripheral of the groove and fitted within the second slot segment; and a stator winding wound on the stator core and passing through the plurality of stator slots and grooves.

Embodiments of another aspect of the present invention provide a method for preparing a motor stator. The method includes steps of: S1) preparing a stator core, first and second insulating members, in which the stator core defines upper and lower ends and has a central through hole and a plurality of stator slots, the stator slots are distributed along a circumferential direction of the stator core, the stator slot includes first and second slot segments, the second insulating member has a central hole and a plurality of grooves corresponding to the plurality of stator slots respectively, and a flange is formed on the second insulating member along a peripheral of the groove and fitted within the second slot segment; S2) disposing the first insulating member in the stator slot and disposing the second insulating member at at least one of the upper and lower ends of the stator core, so that the plurality of grooves are corresponding to the plurality of stator slots respectively and the flange is fitted within the second slot segment; and S3) passing a stator winding through the stator slots and the grooves and winding the stator winding on the stator core.

Embodiments of a further aspect of the present invention provide a motor. The motor includes a motor stator and a motor rotator, and the motor stator may include: a stator core defining upper and lower ends and having a central through hole and a plurality of stator slots, the plurality of stator slots being distributed along a circumferential direction of the stator core and each stator slot including first and second slot segments; a first insulating member disposed in the stator slot; a second insulating member disposed at at least one of the upper and lower ends of the stator core, and defining a central hole and a plurality of grooves corresponding to the plurality of stator slots respectively, and a flange being formed on the second insulating member along a peripheral of the groove and fitted within the second slot segment; and a stator winding wound on the stator core and passing through the plurality of stator slots and grooves.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present invention will become apparent and more readily appreciated from the following descriptions made with reference to the accompanying drawings, in which:

FIG. 1 is a schematic view of a motor stator according to an embodiment of the present invention;

FIG. 2 is a perspective view of a motor stator according to an embodiment of the present invention;

FIG. 3 is a schematic view of a second insulating member of a motor stator according to an embodiment of the present invention;

FIG. 4 is a schematic view of a first insulating member of a motor stator according to an embodiment of the present invention;

FIG. 5 is a partial schematic view of a stator core of a motor stator according to an embodiment of the present invention;

FIG. 6 is a partial cross-sectional view of a stator core of a motor stator according to an embodiment of the present invention;

FIG. 7 is a partial cross-sectional view of a motor stator according to an embodiment of the present invention, in which the stator winding is not shown; and

FIG. 8 is a partial cross-sectional view of a motor stator according to another embodiment of the present invention, in which the stator winding is not shown.

### DETAILED DESCRIPTION

Reference will be made in detail to embodiments of the present invention. The same or similar elements and the elements having same or similar functions are denoted by like reference numerals throughout the descriptions. The embodiments described herein with reference to drawings are explanatory, illustrative, and used to generally understand the present invention. The embodiments shall not be construed to limit the present invention.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present invention be constructed or operated in a particular orientation.

Terms concerning attachments, coupling and the like, such as “connected” and “interconnected”, refer to a relationship in which structures are secured or attached to one another either directly or indirectly through intervening structures, as well as both movable or rigid attachments or relationships, unless expressly described otherwise.

In addition, terms such as “first” and “second” are used herein for purposes of description and are not intended to indicate or imply relative importance or significance. Thereby, a feature defined by “first” or “second” may indicate or imply including one or more this feature. Further, in the specification, “a plurality of” may refer to two or more than two, unless specified otherwise. A motor stator according to embodiments of the present invention will be described with reference to the drawings.

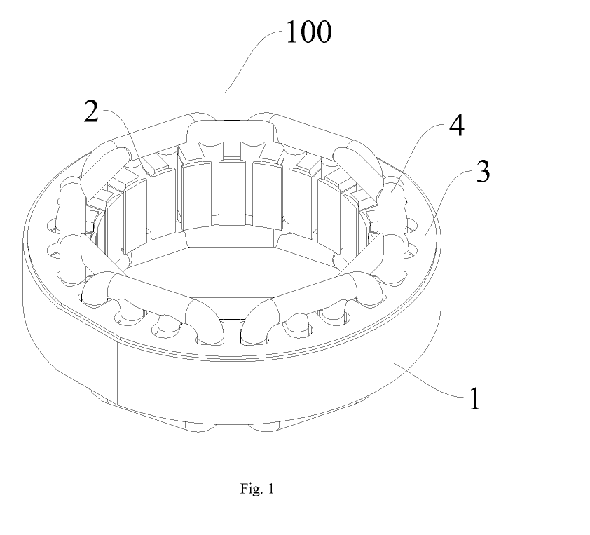

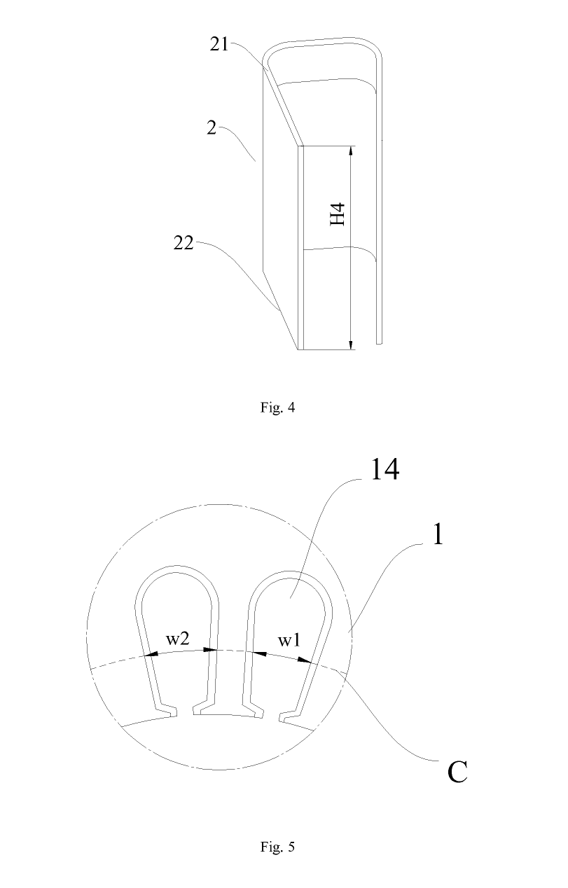

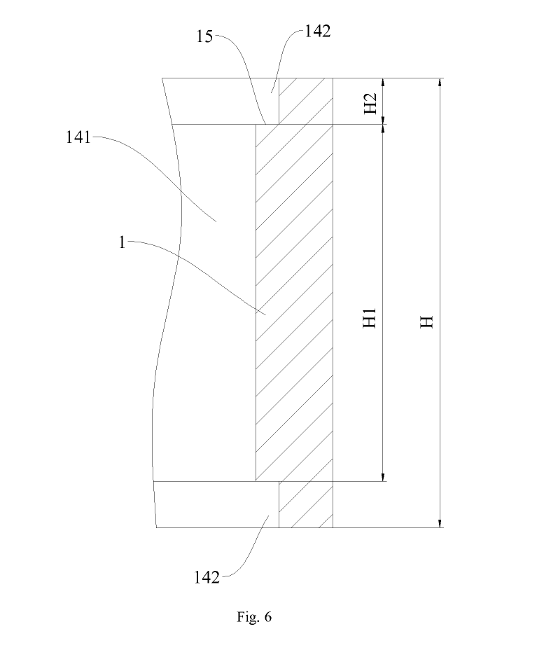

As shown in FIGS. 1-8, a motor stator 100 according to embodiments of the present invention includes a stator core 1, a first insulating member 2, a second insulating part 3 and a stator winding 4. The stator core 1 has an upper end 11 and a lower end 12. The stator core 1 may have a central through hole 13 and a plurality of stator slots 14. The central through hole 13 is adapted to receive a motor rotator (not shown). The plurality of stator slots 14 may be distributed along a circumferential direction of the stator core 1 and each of the stator slots 14 may be communicated with the central through hole 13. Each stator slot 14 may include a first slot segment 141 and a second slot segment 142. A stator tooth 16 may be defined between two adjacent stator slots 14. A first width W1 of the second slot segment 142 may be larger than a second width W2 of the first slot segment 141. In other words, a first width W2 of the second slot segment 142 on a circle C whose center is the same as a center of the stator core 1 may be larger than a second width W1 of the first slot segment 141 on the circle C.

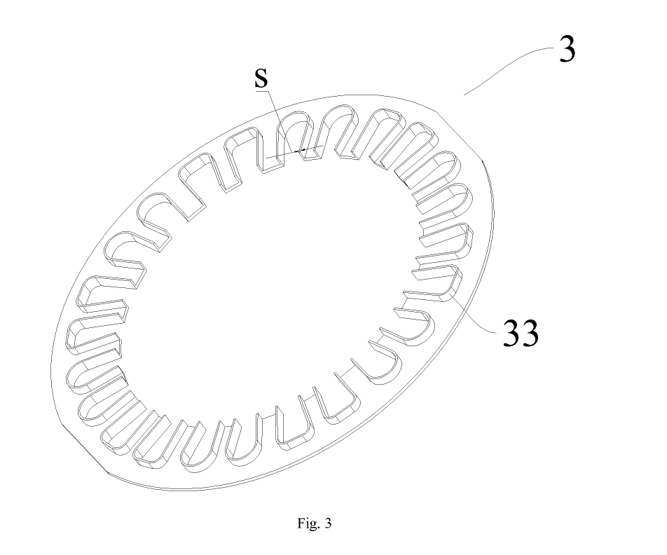

In some embodiments, the second insulating member 3 may be disposed at at least one of the upper and lower ends 11, 12 of the stator core 1. The second insulating member 3 has a central hole 31 and a plurality of grooves 32 corresponding to the plurality of stator slots 14 respectively. A flange 33 may be formed on the second insulating member 3 along a peripheral of the groove 32 and fitted within the second slot segment 142. As shown in FIG. 3, the flange 33 is substantially U-shaped along the peripheral of the groove 32. The stator winding 4 may be wound on the stator core 1 and passing through the plurality of stator slots 14 and grooves 32. Referring to FIG. 3, the flange 33 may have a thickness of about 0.2 mm to about 1.0 mm

In some embodiments, the first insulating member 2 may be disposed in the stator slot 14. In some embodiments, the first insulating member 2 may be insulating paper. For example, the first insulating member 2 may be adhered to an inner wall of the stator slot 14. In an embodiment, the first insulating member 2 may be adhered to an inner wall of the first slot segment 141, thus separating and insulating the stator core 1 and the stator winding 4. As shown in FIG. 5, the first insulating member 2 may be substantially U-shaped so as to be adapted to the cross-section of the stator slot 14. As shown in FIG. 5, the first insulating member 2 may define a first end surface 21 and a second end surface 22 which are flat surfaces. No folded edge is needed to form at the ends of the first insulating member 2 as required in the related art. Therefore, the first insulating member 2 is easy to manufacture and convenient to assemble.

In some embodiments, the flange 33 may be fitted in the second slot segment 142 in an interference fit manner. Thereby the flange 33 may be fitted tightly in the flange 33, which efficiently prevent the second insulating member 3 from escaping from the at least one end of the stator core 1. As shown in FIG. 1, the second insulating member 3 may have a small thickness, and an end of the stator winding 2 may adhered to a surface of the second insulating member 3.

According to embodiments of the present invention, the second insulating member 3 may be disposed at at least one end surface of the stator core 1, and the first insulating member 2 may be disposed on the inner wall of the stator slot 11, which may efficiently prevent a coil 41 of the stator winding 4 from directly contacting with the stator core 1 during assembling of the motor stator 100, which may further reduce a risk of the breakdown of an insulating layer on an outer surface of the coil 41.

In addition, the stator winding 4 may have reduced height (a size of the stator winding 4 in an upper-down direction in FIG. 1), and the winding route of the coil 41 may be reduced. Thereby the amount required for the enameled wire may be reduced and the manufacturing cost may be reduced. The resistance of the stator winding 4 may be reduced, and the loss of the motor may be reduced and the efficiency of the motor may be improved. Further, a voltage-withstanding problem occurred between end surfaces of the stator winding 4 and the stator core 1 may be avoided, and the height of a winding at two ends of the stator core 1 may be reduced, thus saving the space. In some embodiments, the second insulating member 3 may be formed integrally. Alternatively, the second insulating member 3 may be formed by assembling a plurality of sub-members. In some embodiments, the second insulating member 3 may be mounted on the at least one of the upper and lower ends 11, 12 of the stator core 1 via a plastic covering process. Alternatively, the second insulating member 3 may be adhered to the at least one of the upper and lower ends 11, 12 of the stator core 1 via an adhesive.

In an embodiment, a first diameter of the central hole 31 may be larger than a second diameter of the central through hole 13, and a first outer diameter of the second insulating member 3 may be equal to or smaller than a second outer diameter of the stator core 1.

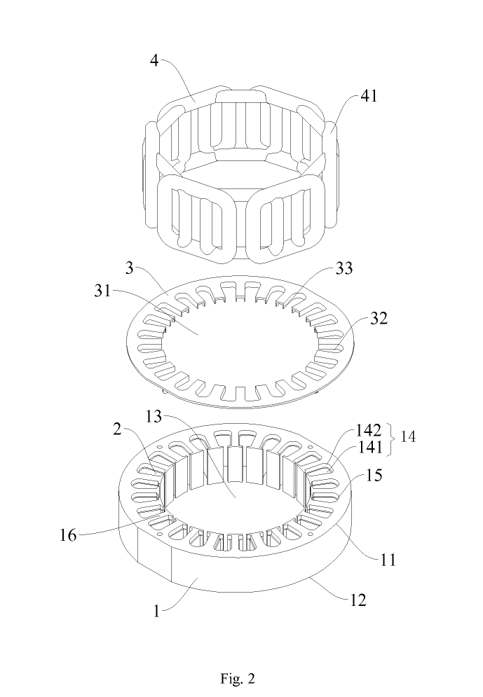

As shown in FIG. 2, in some embodiments, the second insulating member 3 may be disposed at the upper end 11 of the stator core 1, and the first insulating member 2 may extend beyond the lower end 12 of the stator core 1. Alternatively, two second insulating members 3 may be disposed at the upper and lower ends 11, 12 of the stator core 1 respectively.

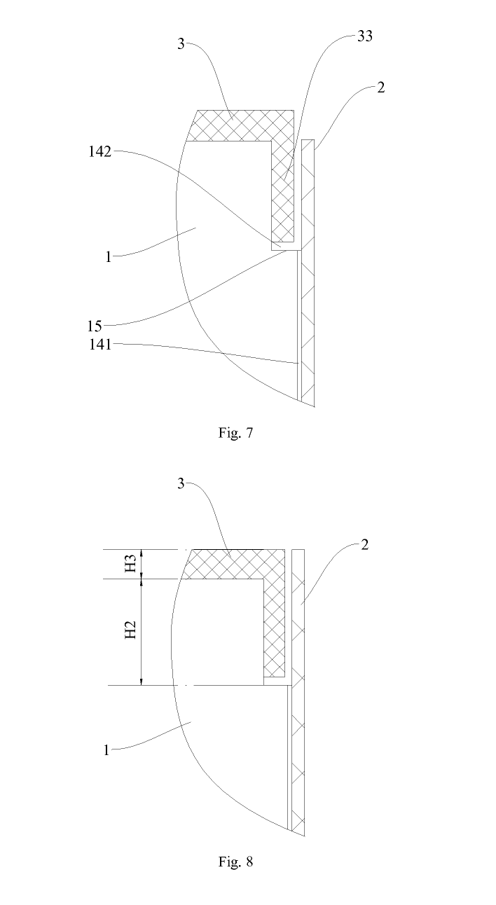

As shown in FIGS. 7 and 8, a step 15 may be formed at at least one end of an inner wall of the stator slot 14 and divide the stator slot 14 into the a first slot segment 141 and a second slot segment 142. A lower surface of the flange 33 may be contacted with an upper surface of the step 15. Alternatively, a gap may be defined between the lower surface of the flange 33 and the upper surface of the step 15. In other words, the depth of the second slot segment 142 may be equal to or larger than the height of the flange 33 (a size of the flange 33 in the upper-down direction).

In some embodiments, no step 15 is formed at the stator slot 14. For example, the second slot segment 142 may have an inversed taper shape. In other words, at least one end of the stator slot 14 may have a bell mouth shape.

As shown in FIG. 7, in some embodiments, two second insulating members 3 are disposed at upper and lower ends 11, 12 of the stator core 1 respectively. A first length H4 of the first insulating member 2 is smaller than a second length H of the stator slot 14, and the first insulating member 2 is completely received in the stator slot 14. In other words, none of a first end 21 and a second end 22 of the first insulating member 2 extends beyond the stator slot 14. The second length H of the stator slot 14 equals to a sum of a length H1 of the first slot segment 141 and a length H2 of the second slot segment 142.

As shown in FIG. 8, alternatively, two second insulating members 3 are disposed at upper and lower ends 11, 12 of the stator core 1 respectively, the first length H4 of the first insulating member 2 is larger than the second length H of the stator slot 14, the first length H4 is smaller than a sum of the second length H and a thickness H3 of the second insulating member 3, and the first insulating member 2 is completely received in the stator slot 14 and the groove 32. In other words, none of the first and second ends 21, 22 of the first insulating member 2 extends beyond the groove 32.

In some embodiments, the stator core 1 may include a first stator core part and a second stator core part. The first stator core part may include a plurality of stacked first stator sheets, and the first slot segment may be defined in the first stator core part. The second stator core part may include a plurality of stacked second stator sheets, and the second slot segment may be defined in the second stator core part.

A width W2 of the second slot segment 142 may be larger than a width W1 of the first slot segment 141. During the winding process of a coil 21 of the stator winding 2, the second slot segment 142 may be used to guide the coil 21, which may facilitate the assembling of the motor stator 100.

In some embodiments, the second insulating member 3 may be formed integrally with the first insulating part 4, for example, formed by injection molding. Then the manufacturing and assembling are both convenient and the manufacturing cost of the motor stator 100 is low.

A method for preparing the motor stator according to embodiments of the present invention may be described in the following.

The method for preparing the motor stator may include steps of:

S1) preparing a stator core, first and second insulating members, in which the stator core defines upper and lower ends and has a central through hole and a plurality of stator slots, the stator slots are distributed along a circumferential direction of the stator core, the stator slot includes first and second slot segments, the second insulating member has a central hole and a plurality of grooves corresponding to the plurality of stator slots respectively, and a flange is formed on the second insulating member along a peripheral of the groove and fitted within the second slot segment;

S2) disposing the first insulating member in the stator slot and disposing the second insulating member at at least one of the upper and lower ends of the stator core, so that the plurality of grooves are corresponding to the plurality of stator slots respectively and the flange is fitted within the second slot segment; and

S3) passing a stator winding through the stator slots and the grooves and winding the stator winding on the stator core.

In some embodiments, the method further includes the following steps after the step S3:

S4) outwardly inclining a wire output end of at least end of the stator winding along an axial direction of the stator core;

S5) connecting the stator winding with a power wire; and

S6) fixing an end of the stator winding and fixing a protector and the power wire at the end of the stator winding.

In some embodiments, the method further may include arranging joints of the power wire and the stator winding in the junction box in the step S5.

In some embodiments, a first length of the first insulating member may be smaller than a second length of the stator slot, and the first insulating member may be completely received in the stator slot. Alternatively, a first length of the first insulating member may be larger than a second length of the stator slot, the first length may be smaller than a sum of the second length and a thickness of the second insulating member, and the first insulating member may be completely received in the stator slot and the groove.

In some embodiments, two second insulating members may be arranged at the upper and lower ends of the stator core respectively.

In some embodiments, the first insulating member may include first and second end surfaces which are flat.

Embodiments of the present invention further provide a motor. The motor according to embodiments of the present invention may include a motor rotator and the above-identified motor stator 100. The motor rotator is received in the central through hole 13 of the stator core 1 of the motor stator 100. It is appreciated that the other structures of the motor according to embodiments of the present invention may be well known to those having ordinary skill in the art, thus related details are omitted herein.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present invention. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present invention, and changes, alternatives, and modifications can be made in the embodiments without departing from spirit, principles and scope of the present invention.

What is claimed is:

1. A motor stator comprising:
a stator core defining upper and lower ends and having a central through hole and a plurality of stator slots, the plurality of stator slots being distributed along a circumferential direction of the stator core and each stator slot comprising first and second slot segments;
a first insulating member disposed in the stator slot;
a second insulating member disposed at at least one of the upper and lower ends of the stator core, and defining a central hole and a plurality of grooves corresponding to the plurality of stator slots respectively, and a flange being formed on the second insulating member along a peripheral of the groove and fitted within the second slot segment; and
a stator winding wound on the stator core and passing through the plurality of stator slots and grooves.

2. The motor stator according to claim 1, wherein a first diameter of the central hole is larger than a second diameter of the central through hole, and a first outer diameter of the second insulating member is equal to or smaller than a second outer diameter of the stator core.

3. The motor stator according to claim 1, wherein the second insulating member is mounted on the at least one of the upper and lower ends of the stator core via a plastic covering process.

4. The motor stator according to claim 1, wherein the flange has a thickness of about 0.2 mm to about 1.0 mm

5. The motor stator according to claim 1, wherein a step is formed at at least one end of the stator slot and divides the stator slot into the first and second slot segments.

6. The motor stator according to claim 1, wherein at least one end of the stator slot has a bell mouth shape.

7. The motor stator according to claim 1, wherein a first length of the first insulating member is smaller than a second length of the stator slot, and the first insulating member is completely received in the stator slot.

8. The motor stator according to claim 1, wherein a first length of the first insulating member is larger than a second length of the stator slot, the first length is smaller than a sum of the second length and a thickness of the second insulating member, and the first insulating member is completely received in the stator slot and the groove.

9. The motor stator according to claim 1, wherein two second insulating members are disposed at the upper and lower ends of the stator core respectively.

10. The motor stator according to claim 1, wherein the first insulating member defines first and second end surfaces which are flat.

11. The motor stator according to claim 1, wherein the stator core comprises:
a first stator core part comprising a plurality of stacked first stator sheets, wherein the first slot segment is defined in the first stator core part; and
a second stator core part comprising a plurality of stacked second stator sheets, wherein the second slot segment is defined in the second stator core part.

12. The motor stator according to claim 1, wherein a first width of the second slot segment on a circle whose center is the same as a center of the stator core is larger than a second width of the first slot segment on the circle.

13. A method for preparing a motor stator, comprising steps of:
S1) preparing a stator core, first and second insulating members, wherein the stator core defines upper and lower ends and has a central through hole and a plurality of stator slots, the stator slots are distributed along a circumferential direction of the stator core, the stator slot comprises first and second slot segments, the second insulating member has a central hole and a plurality of grooves corresponding to the plurality of stator slots respectively, and a flange is formed on the second insulating member along a peripheral of the groove and fitted within the second slot segment;
S2) disposing the first insulating member in the stator slot and disposing the second insulating member at at least one of the upper and lower ends of the stator core, so that the plurality of grooves are corresponding to the plurality of stator slots respectively and the flange is fitted within the second slot segment; and
S3) passing a stator winding through the stator slots and the grooves and winding the stator winding on the stator core.

14. The method according to claim 13, further comprising:
S4) outwardly inclining a wire output end of at least end of the stator winding along an axial direction of the stator core;
S5) connecting the stator winding with a power wire;
S6) fixing an end of the stator winding and fixing a protector and the power wire at the end of the stator winding.

15. The method according to claim 14, further comprising arranging joints of the power wire and the stator winding in the junction box in the step S5.

16. The method according to claim 13, wherein a first length of the first insulating member is smaller than a second length of the stator slot, and the first insulating member is completely received in the stator slot.

17. The method according to claim 13, wherein a first length of the first insulating member is larger than a second length of the stator slot, the first length is smaller than a sum of the second length and a thickness of the second insulating member, and the first insulating member is completely received in the stator slot and the groove.

18. The method according to claim 13, wherein two second insulating members are arranged at the upper and lower ends of the stator core respectively.

19. The method according to claim 13, wherein the first insulating member comprises first and second end surfaces which are flat.

20. A motor comprising a motor stator and a motor rotator, wherein the motor stator comprises:
a stator core defining upper and lower ends and having a central through hole and a plurality of stator slots, the plurality of stator slots being distributed along a circumferential direction of the stator core and each stator slot comprising first and second slot segments;
a first insulating member disposed in the stator slot;
a second insulating member disposed at at least one of the upper and lower ends of the stator core, and defining a central hole and a plurality of grooves corresponding to the plurality of stator slots respectively, and a flange being formed on the second insulating member along a peripheral of the groove and fitted within the second slot segment; and
a stator winding wound on the stator core and passing through the plurality of stator slots and grooves.
